(19) United States
(12) Patent Application Publication
(10) Pub. No.: US 2002/0018680 A1
(43) Pub. Date: Feb. 14, 2002

(54) SHEET TRANSPORT MECHANISM FOR USE IN IMAGE FORMING APPARATUS

(76) Inventors: MASAHIRO MURAKAMI, OSAKA-FU (JP); YOSHITAKE MIYOSHI, KYOTO-FU (JP)

Correspondence Address: JORDAN AND HAMBURG, 122 EAST 42ND STREET, NEW YORK, NY, 10168

(21) Appl. No.: 09/472,381

(22) Filed: Dec. 23, 1999

(30) Foreign Application Priority Data
Dec. 25, 1998 (JP) 10-371382
Nov. 22, 1999 (JP) 11-330900

(51) Int. Cl. G03G 15/00

(52) U.S. Cl. 399/401

(57) ABSTRACT

Disclosed is a sheet transport mechanism for use in an image forming apparatus provided with a sheet feed mechanism for feeding a sheet one by one, an imaging assembly for forming an image on the sheet, a fixing unit for fixing the image on the sheet, a discharge unit for discharging the sheet outside the apparatus, a main transport path extending from the sheet feed mechanism to the discharge unit, a sheet inverting path branched out from the main transport path at a position between the fixing unit and the discharge unit to turn the sheet upside down so as to feed the sheet toward the imaging assembly again, and sheet transport means disposed at a certain position of the main transport path and the sheet inverting path to transport the sheet in a certain direction. The sheet is held by more than one pair of the sheet transport means while guided along the sheet inverting path.

### BACKGROUND OF THE INVENTION AND RELATED ART STATEMENT

The present invention relates to an image forming apparatus such as a copier and a printer that enables an image formation on a sheet of transfer paper (hereinafter, simply referred to as “sheet P”), and more particularly to a sheet transport mechanism for use in an image forming apparatus that enables flip-over of a sheet for double-sided image formation.

FIG. 1 is a diagram showing an example of an image forming apparatus of prior art. A conventional image forming apparatus 1 employs a complex structure as shown in FIG. 1 and described below to prevent an oblique transport of a sheet P onto an intermediate tray 71 so as to feed the sheet P properly toward an imaging assembly for double-sided image formation again (hereinafter, also referred to as “refeed operation”).

Specifically, a sheet P dispensed from a sheet cassette C passes an imaging assembly 3 including a photosensitive drum 31 to thereby form an image on one side surface thereof, has the image fixed thereon by a fixing unit 9, passes a sheet invert/transport guide 52 while guided by a switching means 51, and is transported toward a transport mechanism 6 (hereafter, also referred to as “DS transport mechanism 6”) for double-sided image formation.

When the sheet P is being transported along the sheet invert/transport guide 52, a sheet detector switch S1 is turned on upon detecting a lead end of the sheet P in the transport direction or feed-in direction. Then, the sheet P is guided along a guide member 72 while nipped by an exit roller pair 54 toward the DS transport mechanism 6. Upon passing of a tail end of the sheet P, the sheet detector switch S1 is turned off. A drive mechanism (not shown) for driving a sheet end slapping means 74 starts driving based on the timing of turning off of the sheet detector switch S1.

The sheet end slapping means 74 pivots down about an axis of a pivot shaft 721 (the pivotal movement is not depicted in FIG. 1). The downward pivotal movement of the sheet end slapping means 74 is such that the slapping means 74 slaps down the tail end of the sheet P being transported toward the DS transport mechanism 6 in the feed-in direction and secures landing of the sheet P onto the intermediate tray 71. Namely, an excessive sliding of the sheet P onto the intermediate tray 71 is suppressed by the operation of the sheet end slapping means 74. The sheet end slapping means 74 constitutes a sheet feed-in speed reducer.

Upon a sheet detection sensor S0 on the intermediate tray 71 detecting the sheet P on the intermediate tray 71, a drive means (not shown) for driving a presser roller 73 starts driving. Specifically, the presser roller 73 pivots downward about the axis of the pivot shaft 721 to temporarily render in pressing contact with the sheet P which has landed on the intermediate tray 71 and then rotates in pressing contact with the sheet P to transport the sheet P toward a refeed roller 83 and a refeed belt 84 (namely, in the refeed direction).

At this time, the feed amount of the sheet P in the refeed direction is detected by a rotary plate 75. The rotary plate 75 is a driven member of a very light weight in light contact with the intermediate tray 71. The rotary plate 75 is adapted to detect the feed amount of the sheet P transported in the refeed direction by the presser roller 73 so as to adjust a contact position of the lead end of the sheet P with respect to the refeed direction with a nip portion defined by the refeed roller 83 and the refeed belt 84. When the rotary plate 75 determines the proper contact position, the sheet P on the intermediate tray 71 is properly nipped between the refeed roller 83 and the refeed belt 84. Then, upon driving of the refeed roller 83, the nipped sheet P is guided toward the imaging assembly 3 while being guided by transport roller pairs 85, 86, 87 disposed along a sheet inverting path 81, and a transport roller pair 47. The conventional apparatus has sheet alignment means configured in the above-described manner.

The conventional apparatus has the above complex construction in order to take measures against an oblique transport resulting from a possibility that the sheet P transported to the sheet invert/transport guide 52 may have a curled portion owning to the heat applied by the fixing unit 9.

There is another conventional apparatus provided with sheet alignment means of a different construction from the above conventional apparatus. Specifically, the sheet alignment means of the latter conventional apparatus comprises an oblique correction mechanism operated such that a guide member (not shown) is alternately shifted to contact position and away position toward and away from the opposite sides of a sheet P (depth direction of the apparatus orthogonal to the plane of FIG. 1) for several times after the sheet P has landed on the intermediate tray 71 to correct a possible oblique landing on the intermediate tray 71 for a sheet alignment.

Both of the former and latter conventional apparatuses have the complex construction. The former conventional apparatus is required to have the feed-in speed reducer and the like which temporarily presses the sheet P being received onto the intermediate tray 71 downward and reduces the feed-in speed of the sheet P so as to prevent an oblique landing of the sheet P onto the intermediate tray 71. The latter conventional apparatus is required to have driver means for driving the oblique correction mechanism in addition to a sheet invert/transport mechanism so as to align the sheet P on the intermediate tray 71. Accordingly, in both cases, a space for providing the additional member (driver means for driving the oblique correction mechanism or the sheet alignment means) is required in the apparatus main body. This arrangement hinders the idea of reducing the size of the apparatus main body and leads to complex construction of the apparatus and cost rise due to increase of the number of parts of the apparatus.

### SUMMARY OF THE INVENTION

In view of the above problems residing in the prior art, an object of this invention is to provide a sheet transport mechanism for use in an image forming apparatus that enables preventing an oblique transport of a sheet and producing the apparatus with a reduced size while minimizing the number of parts constituting the apparatus.

According to an aspect of this invention, a sheet transport mechanism for use in an image forming apparatus provided with a sheet feed mechanism for feeding a sheet one by one, an imaging assembly for forming an image on the sheet, a fixing unit for fixing the image on the sheet, a discharge unit for discharging the sheet outside the apparatus, a main transport path extending from the sheet feed mechanism to the discharge unit, and a sheet inverting path branched out from the main transport path at a position between the fixing unit and the discharge unit to turn the sheet upside down so as to feed the sheet toward the imaging assembly again, the sheet transport mechanism comprises sheet transport means disposed at certain positions along the main transport path and the sheet inverting path to transport the sheet in a certain direction, and the sheet transport means are so arranged that the sheet is constantly held by more than one pair of the sheet transport means while guided along the sheet inverting path.

These and other objects, features and advantages of the present invention will become more apparent upon a reading of the following detailed description and accompanying drawings.

### BRIEF DESCRIPTION OF THE DRAWINGS

FIG. 1 is a sectional view of an entire construction of an image forming apparatus of prior art,

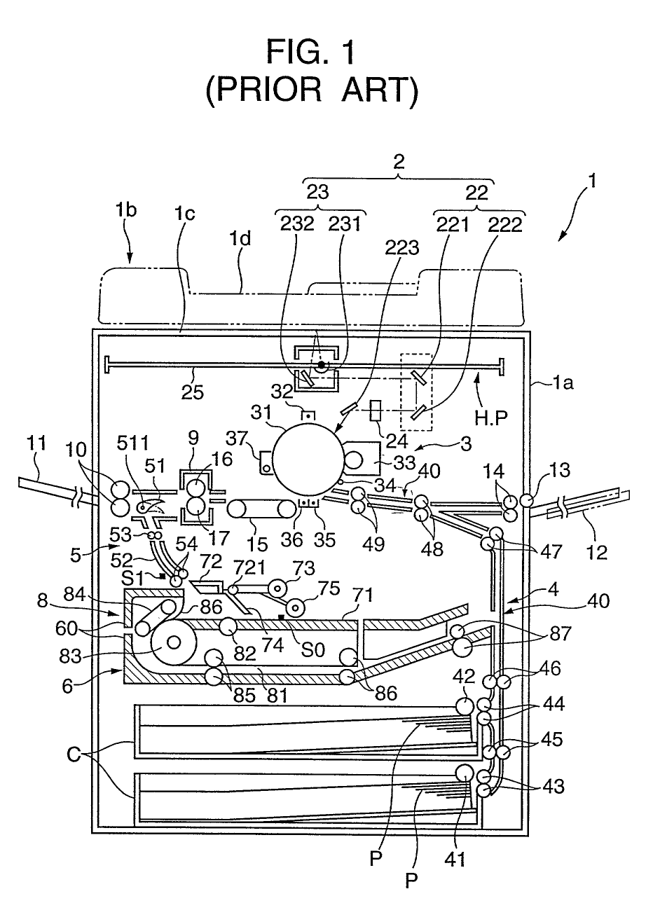

FIG. 2 is a sectional view of an entire construction of an image forming apparatus according to this invention,

FIG. 3 is a sectional view of a transport mechanism for double-sided image formation incorporated with the image forming apparatus according to this invention,

FIG. 4 is an enlarged view of a tip end of a sheet guide and its neighboring area and

FIG. 5 is a timing chart showing a relation between turning on and off of a sheet detection sensor and an activation of an inverting roller pair.

### DETAILED DESCRIPTION OF THE INVENTION

Hereinafter, a sheet transport mechanism for double-sided image formation (DC transport mechanism) for use in an image forming apparatus embodying the present invention is described in detail referring to the accompanying drawings.

[Description of Image Forming Apparatus]

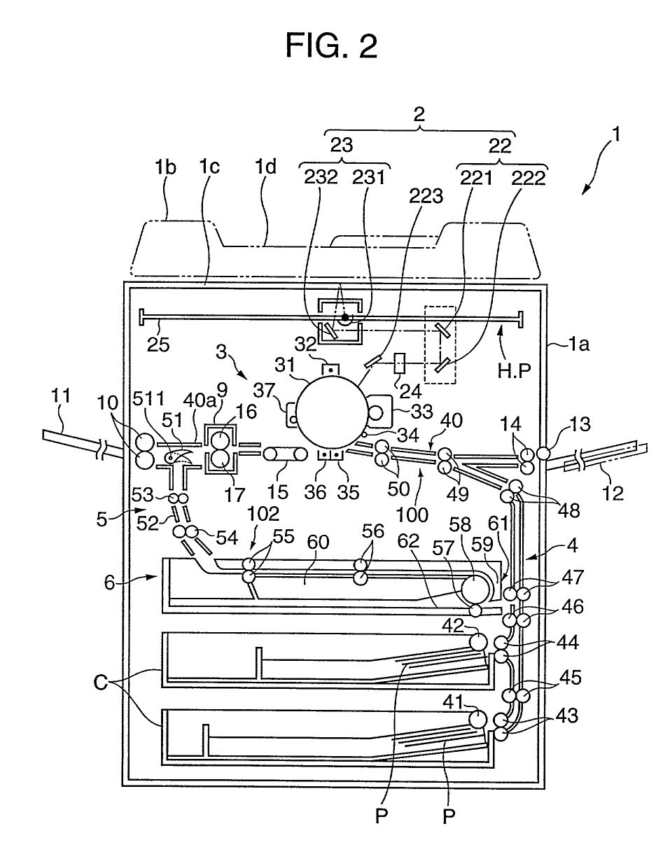

First, an entire construction of the image forming apparatus incorporated with the DC transport mechanism is described with reference to FIG. 2 showing a sectional view of the image forming apparatus.

The image forming apparatus 1 comprises a main body 1a and an automatic document feeder 1b disposed on top of the main body 1a. The outer configuration of the automatic document feeder 1b is depicted by the imaginary line. The main body 1a includes an optic mechanism 2, an imaging assembly 3 with a photosensitive drum 31, a sheet cassette section C, a sheet feed mechanism 4, a fixing unit 9, a discharge roller pair 10, and a discharge tray 11.

The automatic document feeder 1b is constructed such that a set of documents placed on a document setter 1d are fed onto a contact glass 1c one by one and discharged onto the document setter 1d after a document image reading by the optic mechanism 2.

The optic mechanism 2 includes a first optical assembly 23 provided with a light source 231 such as a halogen lamp and a reflective mirror 232 which reciprocate in left and right directions of the apparatus in FIG. 2 to scan the image of the document set on the contact glass 1c, a second optical assembly 22 with reflective mirrors 221, 222 to guide the document image which is a reflected image from the document emitted by the light source 231 toward the imaging assembly 3, a focus lens 24 for focusing the document image on an exposure position over a circumference of the photosensitive drum 31, a pair of guide rails 25 along which the first and second optical assemblies 23, 22 reciprocate respectively, and a drive means (not shown) for reciprocating the first and second optical assemblies 23, 22 at certain speeds respectively along the guide rails 25. A reflective mirror 223 is adapted to guide the document image passing the focus lens 24 toward the exposure position on the photosensitive drum 31.

In this embodiment, an analog optic mechanism is shown as an example of the optic mechanism. It is needless to say that a digital optic mechanism employing a Charge Coupled Device (CCD) for image reading may be applicable.

More specifically, light from the light source 231 is emitted toward the surface of the document placed on the contact glass 1c to form a document image of the reflected light from the document surface. The document image is reflected by the reflective mirrors 232, 221, 222 as shown by the broken line in FIG. 2, and guided to the exposure position on the photosensitive drum 31 via the focus lens 24 and the reflective mirror 223.

Besides the photosensitive drum 31 rotatable in clockwise direction, the imaging assembly 3 includes, in the periphery thereof, a main charger 32, a developer 33, a toner collecting roller 34, an image transfer unit 35, a separating unit 36, and a cleaning unit 37 in this order from upstream with respect to the rotating direction of the photosensitive drum 31. After having its surface uniformly charged by the main charger 32, the photosensitive drum 31 is formed with an electrostatic latent image on the circumferential surface thereof by exposure of the document image. The latent image is developed into a toner image by the developing unit 33, which is in turn transferred onto a sheet P by the transfer unit 35. The sheet P carrying the toner image is separated from the drum surface by the separating unit 36 and is guided to the fixing unit 9 which is described later while applied with a suction force over a transport belt 15. It should be appreciated that the direction from right (side of manual insertion tray 12) to left (side of the discharge tray 11) in FIG. 2 is sheet feed direction before the sheet P is transported to the DS transport mechanism 6, and a transport path from the sheet feed mechanism 4 to a transport guide section 40a defines a main transport path 100.

The sheet feed mechanism 4 is provided on the lower part of the apparatus main body 1a, and includes the sheet cassette section C with cassettes each accommodating a stack of sheets P of a certain size therein. The lower (upper) cassette is arranged with a feed roller 41 (42) for feeding the sheets P stacked therein one by one, and a separation roller pair 43 (44) for preventing a multifeed of the sheets P. The cassette section C further includes transport roller pairs 45, 46, 47, 48, 49 (functioning as transport means for first-stage transport) and a registration roller pair 50 (functioning as transport means for second-stage transport).

The transport belt 15, the fixing unit 9, the discharge roller pair 10, and the discharge tray 11 are provided downstream of the transfer unit 35 with respect to the rotating direction of the photosensitive drum 31.

A transport guide unit 40 is adapted to transport the sheet P fed from the separation roller pair 43 (44) or a separation roller pair 14 toward the discharge roller pair 10 and made of plate-like members opposing each other with a certain space therebetween. The manual insertion tray 12 allows an operator to place a sheet P or a stack of sheets P of a certain size thereon for image formation.

Specifically, on the side of the manual insertion tray 12, there are provided a feed roller 13 and the separation roller pair 14, and a transport path from the manual insertion tray 12 is jointed to the main transport path 100 at the transport roller pair 49. The fixing unit 9 includes an upper heater roller 16 and a lower presser roller 17 and is so constructed that the heater roller 16 is internally provided with a heater and the presser roller 17 makes pressing contact with the heater roller 16 with a certain pressure.

The sheet P dispensed from the lower (upper) cassette of the sheet cassette section C or the manual insertion tray 12 are transported to the registration roller pair 50 as follows. The sheet P dispensed from the lower cassette by the feed roller 41 is transported to the registration roller pair 50 by the transport roller pairs 45, 46, 47, 48, 49 via the separation roller 43. The sheet P dispensed from the upper cassette by the feed roller 42 is transported to the registration roller pair 50 by the transport roller pairs 46, 47, 48, 49 via the separation roller pair 44. The sheet P fed from the manual insertion tray 12 by the feed roller 13 is transported to the transport roller pair 49 and the registration roller pair 50 via the separation roller 14.

The sheet P thus transported to the registration roller pair 50 is temporarily set to a stand-by state upstream from a nip position where the sheet P is to be nipped by the registration roller pair 50 with respect to the sheet feed direction. Thereafter, the second-stage transport initiates when the registration roller pair 50 rotates in synchronism with a scanning/exposure timing of the document image by the optic mechanism 2 to transfer the toner image of the surface of the photosensitive drum 31 onto the sheet P. The sheet P carrying the toner image is separated from the photosensitive drum 31 by the separating unit 36. Then, while carried on the transport belt 15, the sheet P is transported to the downstream-located fixing unit 9 where the toner image on the sheet P is fixed. Thereafter, the sheet P is discharged by the discharge roller pair 10 onto the discharge tray 11.

[Description of DS transport mechanism]

Now, the DS transport mechanism 6 functioning as the sheet transport mechanism in this embodiment is described in association with a sheet inverting path 102 with reference to FIG. 2.

The sheet inverting path 102 is a transport path which is branched out from the main transport path 100 between the fixing unit 9 and the discharge roller pair 10 and returned to the main transport path 100 at the transport roller pair 49 after passing the DS transport mechanism 6.

A switching means 51 is provided between the fixing unit 9 and the discharge roller pair 10 at a certain position of the transport guide section 40a. The switching means 51 is pivotally changeable about an axis of a horizontal shaft 511, by a driver mechanism (not shown) including an electromagnetic solenoid as an example, between a stationary position shown by the imaginary line to guide the sheet P toward the discharge roller pair 10 and a pivot position shown by the solid line to guide the sheet P toward a branch unit 5 which is described later and the DS transport mechanism 6.

With the DS transport mechanism 6 loaded on the apparatus main body 1a, a double-sided image formation is enabled by designating a double-sided image formation mode on an operation panel (not shown) provided on an upper front part of the apparatus main body 1a. When the double-sided image formation mode is designated, the sheet P is guided toward the branch unit 5 and the DC transport mechanism 6 by activation of the switching means 51.

Specifically, the branch unit 5 includes a pair of sheet invert/transport guides 52 disposed opposing to each other to guide the sheet P in a space defined thereby toward the DS transport mechanism 6. The sheet invert/transport guides 52 constituting part of the sheet inverting path 102 is branched out from the transport guide section 40a. A transport roller pair 53 is provided at a certain position of the sheet invert/transport guides 52 to secure transport of the sheet P toward the DS transport mechanism 6. A transport roller pair 54 is provided below the transport roller pair 53 on the sheet invert/transport guides 52 to discharge the sheet P toward the DS transport mechanism 6.

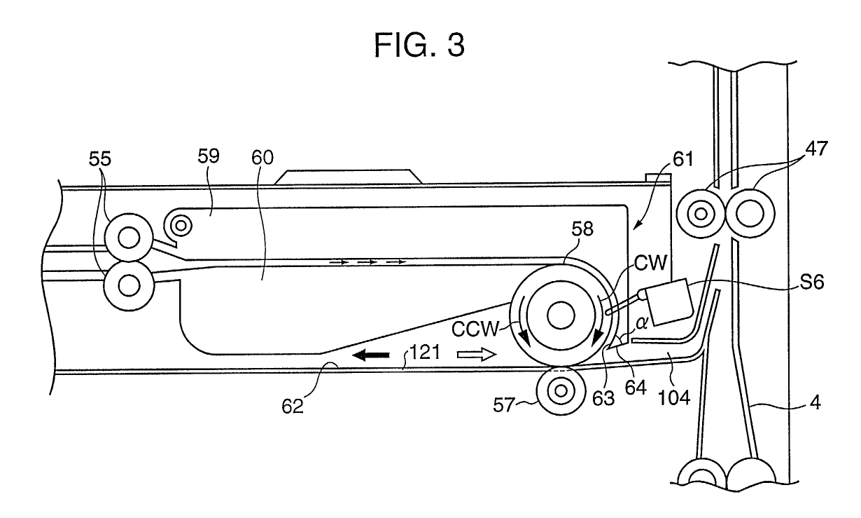

The sheet P, after having its transport direction changed by the switching means 51, is guided down along the sheet invert/transport guides 52 and has a curled portion thereof, if any, which may have caused by the fixing unit 9 corrected while passing the transport roller pairs 53, 54. The sheet P transported to the DS transport mechanism 6 from the transport roller pair 54 is guided in the direction of solid black arrow [symbol] (sheet feed-in direction) in FIG. 3. The sheet P is fed toward an intermediate tray 62 disposed at a lower part of the DS transport mechanism 6 while guided in a space defined by sheet guides 59, 60, and then carried on the intermediate tray 62 while nipped by a pair of inverting rollers 57, 58 disposed on the right side of FIG. 3 in the DS transport mechanism 6.

It should be noted that the length of a segment path measured along the sheet transport path between the two adjacent roller pairs, namely, between the fixing unit 9 (heater roller 16 and the presser roller 17) and the transport roller pair 53, between the transport roller pairs 53 and 54, between the transport roller pairs 54 and 55, between the transport roller pairs 55 and 56, and between the transport roller pair 56 and the pair of inverting rollers 57, 58 is set smaller than the shortest available size of the sheet P onto which an image formation is executable with the image forming apparatus according to this invention. Note that the distance between the adjacent roller pairs can be shorter than the length of the segment path between the adjacent roller pairs along the sheet transport path when the segment path is curved. This arrangement makes it possible to transport the sheet P securely along the sheet inverting path 102 in such a state that the upstream-located roller pair keeps holding the sheet P until the downstream-located roller pair securely nips the lead end of the sheet P in the sheet feed-in direction [symbol] .

More specifically, the sheet P is transported from the main transport path 100 to the inverting path 102 in the following manner: the lead end of the sheet P is in a nipped state by the transport roller pair 53 before the tail end thereof passes the fixing unit 9 when the sheet P is about to exit from the fixing unit 9 toward the DS transport mechanism 6; the lead end of the sheet P subsequently is in a nipped state by the transport roller pair 54 before the tail end thereof passes the transport roller pair 53; the lead end of the sheet P is then in a nipped state by the transport roller pair 55 before the tail end thereof passes the transport roller pair 54; the lead end of the sheet P is then in a nipped state by the transport roller pair 56 before the tail end thereof passes the transport roller pair 55; and finally, the lead end of the sheet P is in a nipped state by the inverting roller pair 57, 58 before the tail end thereof passes the transport roller pair 56. With this arrangement, the sheet P is constantly held by more than one roller pair while guided along the sheet inverting path 102 except that the sheet P is held by the inverting roller pair 57, 58 at the time of refeeding to the imaging assembly 3 in the direction of blank arrow [symbol] . The operation of the inverting roller pair 57, 58 is described later in detail.

With the above-mentioned arrangement, when the double-sided image formation mode is designated, the sheet P is transported along the sheet inverting path 102 in a nipped state by more than one roller pair to prevent a possible oblique transport of the sheet P.

[Description of DS Transport Mechanism]

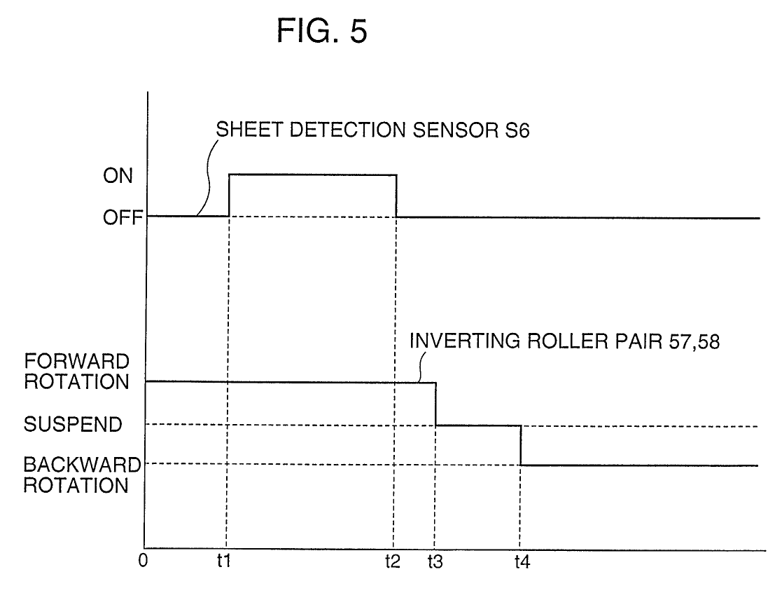

The operation of the DS transport mechanism 6 is described with reference to FIGS. 3 and 5. FIG. 3 is a diagram of the DS transport mechanism with part of the sheet inverting path 102 passing therethrough. FIG. 5 is a timing chart showing a relation between turning on and off of a sheet detection sensor S6 (sheet detection means) and an activation of the inverting roller pair 57, 58.

The sheet detection sensor S6 to detect the sheet P is provided near a right end of the sheet guide 59 in FIG. 3. The sheet guide 59 has a curved portion extending downward along the circumference of the driven roller 58, one of the inverting roller pair 57, 58.

The sheet detection sensor S6 (see FIG. 3) is disposed on the right side of the nip position of the inverting roller pair 57, 58 so that the sensor S6 can detect the tail end of the sheet P in the feed-in direction before the tail end passes the nip position of the inverting roller pair 57, 58 after the timing t1 when the sensor S6 detects the lead end of the sheet P in the feed-in direction.

Specifically, the sensor S6 turns on at the timing t1 when the sheet detection sensor S6 detects the lead end of the sheet P, and then turns off at the timing t2 when the sheet detection sensor S6 detects the tail end of the sheet P. When the sheet detection sensor S6 detects the tail end of the sheet P at the timing t2, the sensor S6 is changed from ON-state to OFF-state. Then, at the timing t3 upon lapse of a time duration after the timing t2, the driving of the drive roller 57, the other one of the inverting roller pair 57, 58, is stopped to thereby suspend feeding of the sheet P in the feed-in direction [symbol] on the intermediate tray 62 (suspend clockwise rotation of the driven roller 58 shown by the arrow CW in FIG. 3). Thereafter, at the timing t4, drive means (not shown) rotatable clockwise and counterclockwise directions initiates driving to reverse the rotation of the drive roller 57 (starts counterclockwise rotation of the driven roller 58 shown by the arrow CCW in FIG. 3) to thereby feed the sheet P in the sheet refeed direction shown by the arrow [symbol] in FIG. 3. Thus, the sheet P starts to be fed toward the imaging assembly 3 again.

With this arrangement, the sheet P once introduced onto the intermediate tray 62 is fed to the imaging assembly 3 again while nipped by the inverting roller pair 57, 58 with the driven roller 58 rotating in the direction CCW. Based on the timing t2 of the sheet detection sensor S6 indicating detection of the tail end of the sheet P, the driven roller 58 stops forward (clockwise) rotation at the timing t3 and then starts backward (counterclockwise) rotation at the timing t4 while securely holding the sheet P between the drive roller 57 and the driven roller 58. Thereby, the transport direction is securely reversed without a possibility of oblique transport.

It may be preferable to set the timing t3 (stop timing of the inverting roller pair 57, 58) such that at least 5 mm is left for the tail end of the sheet P jutting out of the nip position of the inverting roller pair 57, 58 in the feed-in direction onto the intermediate tray 62.

In order to simplify and reduce the size of the construction of the DS transport mechanism or the sheet transport mechanism in this embodiment, the driven roller 58 and the sheet guide 59 altogether constitute an inverting unit 61 for guiding the sheet P. The operation of the inverting unit 61 is described below.

The possible curled portion of the sheet P after passing the fixing unit 9 is substantially corrected by the time when the sheet P is carried onto the intermediate tray 62. There should be, however, considered some cases that the curled portion still remains. Accordingly, it may be preferable to allow the sheet P to be guided along the clearance defined by the outer circumference of the driven roller 58 and a curved wall of the sheet guide 59 extending close to the nip position by the inverting roller pair 57, 58.

In this embodiment, refeed of the sheet P initiates in a state that the sheet P is held by the inverting roller pair 57, 58. Provided that the tail end of the sheet P in the sheet feed-in direction on the intermediate tray 62 should have a curled portion, the following problem would have occurred without a space between a tip end of the sheet guide 59 (lowermost right end of the sheet guide 59 in FIG. 3) and a sheet loading surface 621 of the intermediate tray 62. Specifically, when the sheet P is being fed in the sheet refeed direction by the rotation of the driven roller 58 in CCW direction on the sheet loading surface 621, the possible curled end of the sheet P which has been the tail end of the sheet P in the sheet feed-in direction turns to be the curled lead end of the sheet P in the sheet refeed direction. Thus, jam of the sheet P may result in the DS transport mechanism 6 when the sheet P is coming out of the DS transport mechanism 6 for refeed operation. Providing the space between the tip end of the sheet guide 59 and the sheet loading surface 621 of the intermediate tray 62 takes measures against such a possibility of sheet jam.

More specifically, as shown in FIG. 3, the tip end of the sheet guide 59 is formed of a feed-in guide surface 63 for guiding the sheet P to the nip position by the inverting roller pair 57, 58 at the time of feed-in operation, and a refeed guide surface 64 for guiding the lead end of the sheet P in the refeed direction toward a refeed path 104 at the time of refeed operation. The refeed path 104 is located downstream end of the inverting path 102 with respect to the refeed direction. Positioning the feed-in guide surface 63 and the refeed guide surface 64 in the below-described manner enables to provide such a space between the sheet loading surface 621 and the tip end of the sheet guide 59 as to securely guide the sheet P in the refeed direction without a sheet jam.

When the tail end of the sheet P guided in the feed-in direction along the sheet guide 59 comes out of the tip end of the sheet guide 59, the resilience inherent to the sheet P combined with the rotation of the driven roller 58 in CW direction gives a force to the tail end of the sheet P that slaps back the sheet loading surface 621 of the intermediate tray 62. This action occurs with or without the fact that the tail end of the sheet P has a curled portion. Accordingly, upon start of the refeed operation, the slapping action combined with the resilience inherent to the sheet P enables to securely feed the sheet P along the refeed guide surface 64 toward the refeed path 104 without inadvertently being guided along the feed-in guide surface 63.

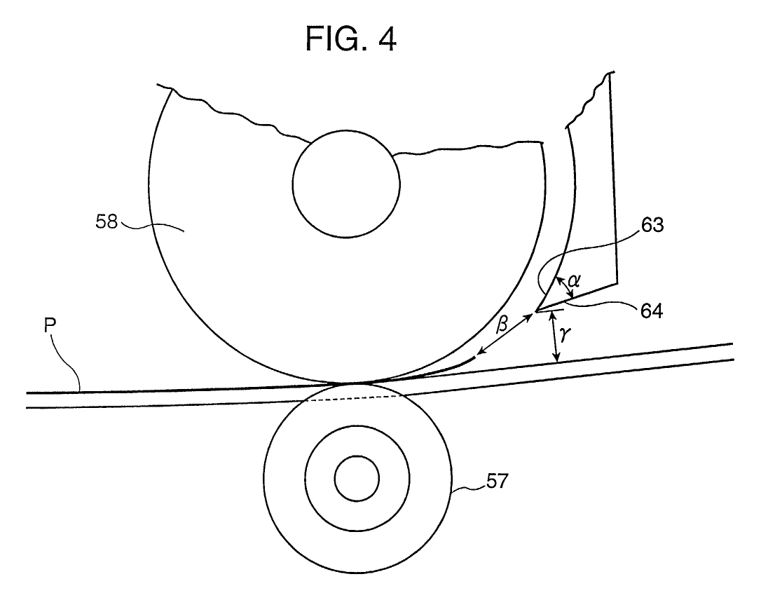

An example of the positional relation among the elements for securing refeed operation of the sheet P is described herein along with FIG. 4. It should be noted that the following is a mere example of the preferred embodiments derived from the experiment conducted by the inventor(s) of this application and does not delimit the invention by itself.

A result of the experiment revealed that, when the diameter of the driven roller 58 is 18 mm, the clearance between the outer circumference of the driven roller 58 and the feed-in guide surface 63 at the tip end thereof is 1.0 mm, and the clearance between the refeed guide surface 64 at the lowermost end thereof and the sheet loading surface 621 of the intermediate tray 62 is γ, it may be preferable to set the clearance γ in the range of 3 mm ≦γ≦7 mm.

Further, it was found that, when the distance between the tail edge of the sheet P in the feed-in direction at the timing t3 of suspending CW rotation of the driven roller 58 and the refeed guide surface 64 at the lowermost end thereof is set β, it may be preferable to establish the relation of γ and β as 0<γ≦β+3 mm.

More preferable positional relation to satisfy the above condition was: γ=5 to 7 mm, and β=5 mm.

It was also found that the angle α of the tip end of the sheet guide 59 defined by the feed-in guide surface 63 and the refeed guide surface 64 may preferably be 90° or less.

As an altered arrangement, it may be preferable to curve the refeed guide surface 64 to facilitate refeed of the sheet P.

In the above embodiment, the plural transport roller pairs are provided as the transport means. Alternatively, a set of a roller and a belt, a pair of belts, or a construction in which the sheet P is guided over a belt while applied with a suction force may be applicable as the transport means.

In the embodiment, the sheet transport mechanism is described in association with double-sided image formation. Alternatively, the present invention is applicable to an image forming apparatus with a so-called composite image formation mode capable of forming plural sub-images are formed in combination on a surface of the sheet P.

In the foregoing embodiment, the mechanism for refeeding the sheet P is such that the inverting roller pair 57, 58 has its rotation reversed based on the timing t2 when the sheet detection sensor S6 detects the tail end of the sheet P in the feed-in direction while guided in the DS transport mechanism 6 for refeeding operation. An altered arrangement may be such that the inverting roller pair 57, 58 has its rotation reversed upon lapse of a certain time duration after the timing t1 of detecting the lead end of the sheet P in the feed-in direction in accordance with the length of the sheet P in the feed-in direction.

To sum up this invention, according to an aspect of this invention, a sheet transport mechanism of this invention is used in an image forming apparatus provided with a sheet feed mechanism for feeding a sheet one by one, an imaging assembly for forming an image on the sheet, a fixing unit for fixing the image on the sheet, a discharge unit for discharging the sheet outside the apparatus, a main transport path extending from the sheet feed mechanism to the discharge unit, a sheet inverting path branched out from the main transport path at a position between the fixing unit and the discharge unit to turn the sheet upside down so as to feed the sheet toward the imaging assembly again, the sheet transport mechanism including sheet transport means disposed at certain positions of the main transport path and the sheet inverting path to transport the sheet in a certain direction. One of the features of this invention is that the sheet transport means are so arranged that the sheet is constantly held by more than one pair of the sheet transport means while guided along the sheet inverting path.

In the above arrangement, the sheet with one side thereof carrying an image is constantly held by more than one pair of the transport means while guided along the sheet inverting path. This arrangement makes it possible to turn the sheet upside down without a possibility of oblique transport of the sheet to enable secure return of the sheet to the main transport path for image formation on the opposite side of the sheet. This arrangement does not necessitate an additional sheet alignment means for correcting an oblique transport of the sheet and enables flip-over of the sheet with a simplified mechanism.

According to another aspect of this invention, the sheet transport mechanism of this invention comprises: sheet transport means disposed at certain positions along the main transport path and the sheet inverting path to transport the sheet in a certain direction; an intermediate tray disposed on the sheet inverting path to temporarily receive the sheet thereon; and a pair of inverting rollers for guiding the sheet onto the intermediate tray in such a manner that a side of the sheet facing downward when the sheet is introduced to the sheet transport mechanism faces upward when the sheet is about to be fed toward the imaging assembly again. The sheet transport means are so arranged that the sheet is constantly held by more than one pair of the sheet transport means while guided along the sheet inverting path, and held by the pair of inverting rollers at the time of feeding toward the imaging assembly again.

In the above arrangement, the sheet with one side thereof carrying an image is constantly held by more than one pair of the transport means while guided along the sheet inverting path. This arrangement enables to flip over the sheet without a possibility of oblique transport and securely guide the sheet onto the intermediate tray in a nipped state by the inverting roller pair. Then, the sheet is returned to the main transport path while guided by the inverting roller pair for image formation on the opposite side of the sheet. This arrangement does not necessitate an additional sheet alignment means for correcting an oblique transport of the sheet and enables flip-over of the sheet with a simplified mechanism.

According to yet another aspect of this invention, the sheet transport mechanism of this invention comprises: sheet transport means disposed at certain positions along the main transport path and the sheet inverting path to transport the sheet in a certain direction; an intermediate tray disposed on the sheet inverting path to temporarily receive the sheet thereon; a set of sheet guides opposing each other with a certain clearance therebetween to guide the sheet toward the intermediate tray in the clearance; and a pair of inverting rollers for guiding the sheet onto the intermediate tray in such a manner that a side of the sheet facing downward when the sheet is introduced to the sheet transport mechanism faces upward when the sheet is about to be fed toward the imaging assembly again. A tip end of the one of the set of the sheet guides located downstream end thereof with respect to a sheet feed-in direction toward the intermediate tray is defined by a feed-in guide surface for guiding a lead end of the sheet in the feed-in direction to a nip position defined by the pair of the inverting rollers at the time of feed-in operation and a refeed guide surface for guiding a lead end of the sheet in a refeed direction opposite to the feed-in direction at the time of refeed operation.

In the above arrangement, the sheet with one side thereof carrying an image is constantly held by more than one pair of the transport means while guided in the clearance defined by the set of sheet guides of the sheet inverting path. This arrangement enables to flip over the sheet without a possibility of oblique transport of the sheet and securely guide the sheet onto the intermediate tray in a nipped state by the inverting roller pair. Then, the feed-in operation of the sheet is temporarily suspended in this state. At this time, the lead end of the sheet in the feed-in direction is guided along the feed-in guide surface of the one of the sheet guides to the nip position of the inverting roller pair at the time of feed-in operation, whereas the lead end of the sheet in the refeed direction is guided along the refeed guide surface of the sheet guide at the time of refeed operation to thereby return the sheet toward the main transport path for image formation on the opposite side of the sheet. This arrangement does not necessitate an additional guide means for guiding the sheet at the time of refeed operation and enables secure refeeding of the sheet. Accordingly, reliability of the performance of the image forming apparatus is improved and the apparatus is produced with a reduced size.

According to still another aspect of this invention, the feed-in guide surface may preferably be disposed away from a circumference of the one of the pair of the inverting rollers by a certain clearance and may be so shaped as to follow the circumference thereof.

In this arrangement, the sheet is securely transported to the nip position of the inverting roller pair while guided in the clearance defined by the feed-in guide surface and the circumference of the inverting roller.

According to still another aspect of this invention, the sheet transport mechanism of this invention may further comprise a sheet detection means disposed near the tip end of the sheet guide for detecting the sheet and the inverting roller pair may initiate feeding of the sheet in the refeed direction based on a detection signal of the sheet detection means indicating detection of the sheet.

In this arrangement, since the sheet detection means is provided near the nip position of the inverting roller pair, the sheet is securely detected by the sheet detection means.

According to yet another aspect of this invention, the inverting roller pair may initiate feeding of the sheet in the refeed direction based on a detection signal of the sheet detection means indicating detection of the tail end of the sheet in the sheet feed-in direction.

In this arrangement, the sheet is securely detected by the sheet detection means with a simplified control mechanism.

According to still further aspect of this invention, the feed-in guide surface and the refeed guide surface of the sheet guide may preferably define a substantially L-shape in vertical section of the image forming apparatus with an angle a satisfying the relation: α≦90°.

In this arrangement, the sheet is guided toward the intermediate tray in a nipped state by the inverting roller pair while guided along the feed-in guide surface at the time of feed-in operation, whereas returned to the main transport path via a refeed path with the lead end of the sheet in the refeed direction guided along the refeed guide surface at the time of refeed operation.

According to furthermore aspect of this invention, the sheet transport means may include a pair of transport rollers. This arrangement simplifies the construction of the sheet transport means.

According to yet another aspect of this invention, the inverting roller pair may preferably rotate in a direction opposite to a direction at the time of feed-in operation of the sheet on the intermediate tray when the sheet is fed toward the imaging assembly again.

In this arrangement, the sheet is introduced to the intermediate tray in the feed-in direction while held by the inverting roller pair at the time of feed-in operation, and then fed in the refeed direction opposite to the feed-in direction on the interemediate tray while kept in the nipped state at the time of refeed operation with rotation of the inverting roller pair reversed to each other.

As this invention may be embodied in several forms without departing from the spirit of essential characteristics thereof, the present embodiment is therefore illustrative an not restrictive, since the scope of the invention is defined by the appended claims rather than by the description preceding them, and all changes that fall within meets and bounds of the claims, or equivalence of such meets and bounds are therefore intended to embraced by the claims.

What is claimed is:

1. A sheet transport mechanism for use in an image forming apparatus provided with a sheet feed mechanism for feeding a sheet one by one, an imaging assembly for forming an image on the sheet, a fixing unit for fixing the image on the sheet, a discharge unit for discharging the sheet outside the apparatus, a main transport path extending from the sheet feed mechanism to the discharge unit, and a sheet inverting path branched out from the main transport path at a position between the fixing unit and the discharge unit to turn the sheet upside down so as to feed the sheet toward the imaging assembly again,
the sheet transport mechanism comprising sheet transport means disposed at certain positions along the main transport path and the sheet inverting path to transport the sheet in a certain direction, and the sheet transport means are so arranged that the sheet is constantly held by more than one pair of the sheet transport means while guided along the sheet inverting path.

2. The sheet transport mechanism according to claim 1, wherein the sheet transport means includes a pair of transport rollers.

3. The sheet transport mechanism according to claim 2, wherein the sheet transport rollers are so arranged that the length of path segment between nipping positions of any combination of adjacent transport roller pairs measured along the sheet inverting path is set smaller than the length of the minimal size sheet for possible use of the image forming apparatus in a sheet transport direction.

4. The sheet transport mechanism according to claim 2, wherein the inverting roller pair rotates in a direction opposite to a direction at the time of feed-in operation of the sheet on the intermediate tray when the sheet is fed toward the imaging assembly again.

5. A sheet transport mechanism for use in an image forming apparatus provided with a sheet feed mechanism for feeding a sheet one by one, an imaging assembly for forming an image on the sheet, a fixing unit for fixing the image on the sheet, a discharge unit for discharging the sheet outside the apparatus, a main transport path extending from the sheet feed mechanism to the discharge unit, and a sheet inverting path branched out from the main transport path at a position between the fixing unit and the discharge unit to turn the sheet upside down so as to feed the sheet toward the imaging assembly again, the sheet transport mechanism comprising:
sheet transport means disposed at certain positions of the main transport path and the sheet inverting path to transport the sheet in a certain direction,
an intermediate tray disposed on the sheet inverting path to temporarily receive the sheet thereon; and
a pair of inverting rollers for guiding the sheet onto the intermediate tray in such a manner that a side of the sheet facing downward when the sheet is introduced to the sheet transport mechanism faces upward when the sheet is about to be fed toward the imaging assembly again,
the sheet transport means are so arranged that sheet is constantly held by more than one pair of the sheet transport means while guided along the sheet inverting path and held by the pair of inverting rollers at the time of feeding toward the imaging assembly again.

6. The sheet transport mechanism according to claim 5, wherein the sheet transport means includes a pair of transport rollers.

7. The sheet transport mechanism according to claim 6, wherein the inverting roller pair rotates in a direction opposite to a direction at the time of feed-in operation of the sheet on the intermediate tray when the sheet is fed toward the imaging assembly again.

8. The sheet transport mechanism according to claim 6, wherein the sheet transport rollers are so arranged that the length of path segment between nipping positions of any combination of adjacent transport roller pairs measured along the sheet inverting path is set smaller than the length of the minimal size sheet for possible use of the image forming apparatus in a sheet transport direction.

9. A sheet transport mechanism for use in an image forming apparatus provided with a sheet feed mechanism for feeding a sheet one by one, an imaging assembly for forming an image on the sheet, a fixing unit for fixing the image on the sheet, a discharge unit for discharging the sheet outside the apparatus, a main transport path extending from the sheet feed mechanism to the discharge unit, and a sheet inverting path branched out from the main transport path at a position between the fixing unit and the discharge unit to turn the sheet upside down so as to feed the sheet toward the imaging assembly again, the sheet transport mechanism comprising:
sheet transport means disposed at a certain position of the main transport path and the sheet inverting path to transport the sheet in a certain direction;
an intermediate tray disposed on the sheet inverting path to temporarily receive the sheet thereon;
a set of sheet guides opposing each other with a certain clearance therebetween to guide the sheet toward the intermediate tray in the clearance; and
a pair of inverting rollers for guiding the sheet onto the intermediate tray in such a manner that a side of the sheet facing downward when the sheet is introduced to the sheet transport mechanism faces upward when the sheet is about to be fed toward the imaging assembly again,
a tip end of the one of the set of the sheet guides located downstream end thereof with respect to a sheet feed-in direction toward the intermediate tray is defined by a feed-in guide surface for guiding a lead end of the sheet in the sheet feed-in direction to a nip position defined by the pair of the inverting rollers at the time of feed-in operation and a refeed guide surface for guiding a lead end of the sheet in a refeed direction opposite to the feed-in direction at the time of refeed operation.

10. The sheet transport mechanism according to claim 9, wherein the sheet transport means includes a pair of transport rollers.

11. The sheet transport mechanism according to claim 9, wherein the feed-in guide surface is disposed away from a circumference of the one of the pair of the inverting rollers by a certain clearance and is so shaped as to follow the circumference thereof.

12. The sheet transport mechanism according to claim 9 further comprising a sheet detection means disposed near the tip end of the sheet guide for detecting the sheet, wherein the inverting roller pair initiates feeding of the sheet in the refeed direction based on a detection signal of the sheet detection means indicating detection of the sheet.

13. The sheet transport mechanism according to claim 12, wherein the inverting roller pair initiates feeding of the sheet in the refeed direction based on a detection signal of the sheet detection means indicating detection of the tail end of the sheet in the sheet feed-in direction.

14. The sheet transport mechanism according to claim 10, wherein the feed-in guide surface and the refeed guide surface of the sheet guide define an angle α in vertical section of the image forming apparatus, where α≦90°.

15. The sheet transport mechanism according to claim 10, wherein the inverting roller pair rotates in a direction opposite to a direction at the time of feed-in operation of the sheet on the intermediate tray when the sheet is fed toward the imaging assembly again.

16. The sheet transport mechanism according to claim 10, wherein the sheet transport rollers are so arranged that the length of path segment between nipping positions of any combination of adjacent transport roller pairs measured along the sheet inverting path is set smaller than the length of the minimal size sheet for possible use of the image forming apparatus in a sheet transport direction.
